(19) United States
(12) Patent Application Publication
(10) Pub. No.: US 2007/0085370 A1
(43) Pub. Date: Apr. 19, 2007

(54) Holder for debris during transport to a disposal site

(76) Inventors: Chad M. Barone, North Scituate, RI (US); Nicole L. Barone, North Scituate, RI (US)

Correspondence Address: JAMES RAY & ASSOCIATES, 2640 PITCAIRN ROAD, MONROEVILLE, PA, 15146, US

(21) Appl. No.: 11/580,483

(22) Filed: Oct. 13, 2006

Related U.S. Application Data
(60) Provisional application No. 60/727,772, filed on Oct. 18, 2005.

(51) Int. Cl. B60P 7/02

(52) U.S. Cl. 296/100.16

(57) ABSTRACT

An apparatus for holding and transporting preselected items from one place to another. The apparatus includes a tarp like member having each of a predetermined size and a predetermined shape. A first mechanism is engageable with at least one preselected edge of such tarp like member for facilitating movement of the apparatus. The first mechanism includes at least a pair of apertures formed therethrough. Further, there is a second mechanism engageable through each of such pair of apertures for pulling the apparatus at least one of by hand and with a mechanical means.

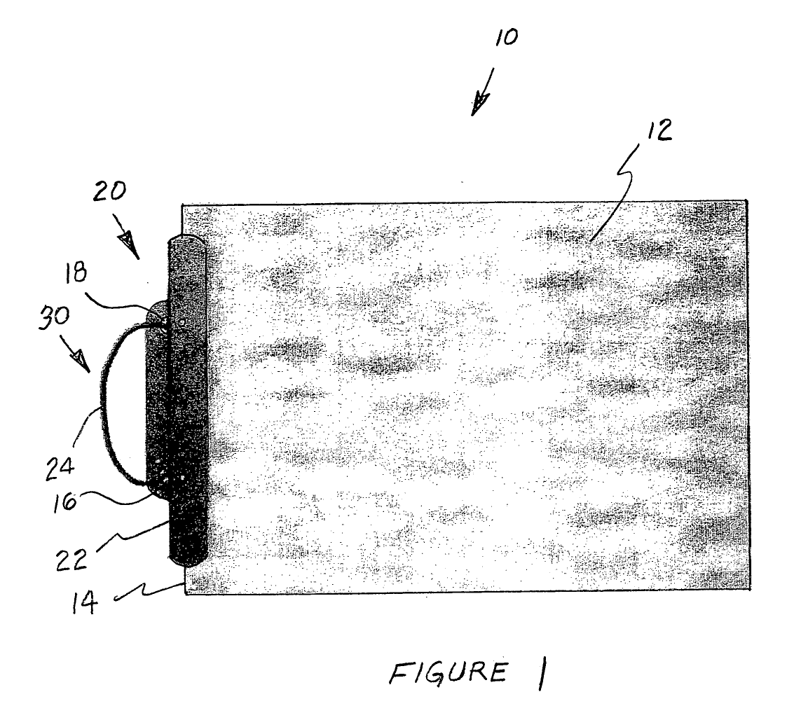

### CROSS-REFERENCE TO RELATED APPLICATION

This application is closely related to and claims benefit from U.S. Provisional Patent Application Ser. No. 60/727,772 filed on Oct. 18, 2005.

### FIELD OF THE INVENTION

Although not specifically limited thereto, the present invention relates, in general, to disposal of debris generated while doing yard work such as, for example, leaves, grass cuttings, hedge trimmings, etc. and, more particularly, this invention relates to a holder for such debris while it is being transported to a disposal site.

### BACKGROUND OF THE INVENTION

Prior to the conception and development of the instant invention, prior art type equipment such as wheelbarrows and wagons have been extensively used to haul yard debris and/or other preselected items from one place to another. However, these prior art type wheelbarrows and wagons are frequently quite prone to tipping and/or dumping the load being carried. This results in added work to pick up the load and continue on with the work and/or to the disposal site.

Furthermore, an additional disadvantage of these particular types of prior art equipment is that, due to their open nature, they are susceptible to wind blowing the contents carried they are susceptible to wind blowing the contents carried therein out of the equipment. This is particularly the situation when loose dry leaves, grass cuttings and hedge trimmings are being transported.

### SUMMARY OF THE INVENTION

The present invention provides an apparatus for holding debris or other preselected objects while being transported to one of a work place and a disposal site. The apparatus includes a tarp like member having each of a predetermined size and a predetermined shape. A first means is engageable with at least one preselected edge of such tarp like member for facilitating movement of the apparatus. The first means includes at least a pair of apertures formed therethrough. Further, there is a second means engageable through each of such at least a pair of apertures for pulling the apparatus at least one of by hand and with a mechanical means.

### OBJECTS OF THE INVENTION

It is, therefore, one of the primary objects of the present invention to provide an apparatus for holding debris or other preselected objects while being transported to one of a work place and a disposal site which substantially eliminates the possibility of accidentally dumping the debris or other objects.

Another object of the present invention is to provide an apparatus for holding debris or other preselected objects while being transported to one of a work place and a disposal site which is easy to use.

Still another object of the present invention is to provide an apparatus for holding debris or other preselected objects while being transported to one of a work place and a disposal site which is relatively inexpensive to produce.

Yet another object of the present invention is to provide an apparatus for holding debris or other preselected objects while being transported to one of a work place and a disposal site which is relatively lightweight.

A further object of the present invention is to provide an apparatus for holding debris or other preselected objects while being transported to one of a work place and a disposal site which requires a minimum of storage space.

An additional object of the present invention is to provide an apparatus for holding debris or other preselected objects while being transported to one of a work place and a disposal site which can be moved by hand or by a powered mechanical means.

In addition to the several objects and advantages of the present invention which have been described in detail above, it should be obvious that additional objects and advantages of such invention will become more readily apparent to those persons who are skilled in the relevant art from the following more detailed description, particularly, when such description is taken in conjunction with the attached drawing figure and with the appended claims.

### BRIEF DESCRIPTION OF THE DRAWINGS

The sole FIGURE is a plan view of a presently preferred embodiment of the invention.

### DETAILED DESCRIPTION OF A PRESENTLY PREFERRED AND VARIOUS ALTERNATIVE EMBODIMENTS OF THE INVENTION

Now reference is made more particularly to the sole FIGURE. Illustrated therein is an apparatus, generally designated 10, for holding and transporting preselected items (not shown) from one place to another. Such apparatus 10 includes a tarp like member 12 having each of a predetermined size and a predetermined shape.

It is presently preferred that the predetermined shape of such tarp like member 12 will be generally rectangular and that the predetermined size of such tarp like member 12 will be between about 7.0 feet to about 9.0 feet in width and about 9.0 feet to about 11.0 feet in length. The most preferred predetermined size of such tarp like member 12 will be about 8.0 feet in width and about 10.0 feet in length.

This tarp like member 12 can be manufactured from one of canvas, vinyl and reinforced mesh type material. It is presently preferred that such tarp like member 12 be manufactured from canvas.

There is a first means, generally designated 20, provided which is engageable with at least one preselected edge 14 of such canvas tarp like member 12 for facilitating movement of such apparatus 10. The first means 20 includes at least a pair of apertures 16 and 18 formed therethrough.

In the presently preferred embodiment of the invention the first means 20 includes at least one clamp like member 22 having such pair of apertures 16 and 18 formed therethrough. Such clamp like member 22 is secured to the preselected edge 14 of the tarp like member 12.

Finally, there is a second means, generally designated 30, engageable through each of such pair of apertures 16 and 18 for pulling the apparatus 10 at least one of by hand and with a mechanical means (not shown). Such second means 30 engageable through each of the pair of apertures 16 and 18 for pulling the apparatus is selected from one of a cable, rope and chain. The most preferred second means 30 is a rope 24. Additionally, the presently preferred mechanical means is one of a lawn tractor and an all terrain vehicle.

While in accordance with the Patent Statutes both a presently preferred and a number of alternative embodiments of the present invention have been described above in sufficient detail to allow a person skilled in the relevant art to make and use the same it should be noted that various additional modifications and adaptations can be made by such person without departing from either the spirit of the invention or the scope of the appended claims.

I claim:

1. An apparatus for holding and transporting preselected items from one place to another, said apparatus comprising:
(a) a tarp like member having each of a predetermined size and a predetermined shape;
(b) a first means engageable with at least one preselected edge of said tarp like member for facilitating movement of said apparatus, said first means including at least a pair of apertures formed therethrough; and
(c) a second means engageable through each of said at least a pair of apertures for pulling said apparatus at least one of by hand and with a mechanical means.

2. An apparatus, according to claim 1, wherein said tarp like member is selected from one of canvas, vinyl and reinforced mesh type material.

3. An apparatus, according to claim 1, wherein said tarp like member is canvas.

4. An apparatus, according to claim 3, wherein said predetermined shape of said tarp like member is generally rectangular.

5. An apparatus, according to claim 4, wherein said predetermined size of said tarp like member is between about 7.0 feet to about 9.0 feet in width and about 9.0 feet to about 11.0 feet in length.

6. An apparatus, according to claim 5, wherein said predetermined size of said tarp like member is 8.0 feet in width and about 10.0 feet in length.

7. An apparatus, according to claim 1, wherein said first means includes at least one clamp like member having said pair of apertures formed therethrough secured to said preselected edge of said tarp like member.

8. An apparatus, according to claim 7, wherein said second means engageable through each of said pair of apertures for pulling said apparatus is selected from one of a cable, rope and chain.

9. An apparatus, according to claim 8, wherein said second means engageable through each of said pair of apertures for pulling said apparatus is said rope.

10. An apparatus, according to claim 9, wherein such mechanical means is one of a lawn tractor and an all terrain vehicle.
